(19) United States
(12) Patent Application Publication
(10) Pub. No.: US 2005/0240308 A1
(43) Pub. Date: Oct. 27, 2005

(54) Method and device for controlling walking of legged robot

(75) Inventors: Kenji Kaneko, Tsukuba-shi (JP); Kazuhiko Yokoi, Tsukuba-shi (JP); Fumio Kanehiro, Tsukuba-shi (JP); Shuuji Kajita, Tsukuba-shi (JP); Kiyoshi Fujiwara, Tsukuba-shi (JP); Hirohisa Hirukawa, Tsukuba-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nat Institute of Advance Indust Science & Tech., Tokyo (JP)

(21) Appl. No.: 10/511,608

(22) PCT Filed: May 7, 2003
(86) PCT No.: PCT/JP03/05692

§ 371 Date: Apr. 19, 2005

(30) Foreign Application Priority Data
May 7, 2002 (JP) 2002-131120

(51) Int. Cl. G06F 19/00

(52) U.S. Cl. 700/245

(57) ABSTRACT

The present invention provides a walking control method and a walking control apparatus for achieving stable attitude control of a legged robot. In the walking control of the legged robot, basically, a foot-sole coordinate system based on sole positions and having at least a first coordinate axis in a direction connecting soles of both legs and a second coordinate axis perpendicular to the first coordinate axis in a horizontal plane is used as a control coordinate system, and attitude control is performed with different control characteristics for the first and second coordinate axes. Accordingly, the legged robot includes sole position sensors for detecting the sole positions of ground-contacting legs, ground contact sensors for detecting the state of the ground-contacting legs or a motion controller for generating the state of the ground-contacting legs, a control device which performs the walking control using a coordinate system based on the direction connecting the soles of the legs as a control coordinate system in accordance with the detected sole positions and the state of the ground-contacting legs, and leg actuators controlled by the control device.

### TECHNICAL FIELD

The present invention relates to methods and apparatuses for walking control of legged robots, and more specifically to a control method for achieving stable attitude control of a legged robot and a walking control apparatus having the control function.

### BACKGROUND ART

Japanese Unexamined Patent Application Publication No. 11-300660 discloses a control apparatus for a legged robot obtained by designing a stable control system based on a Cartesian coordinate system (moving-direction coordinate system) having the moving direction of the legged robot as an axis. A walking control apparatus, for example, is thus provided.

In the known apparatus, walking patterns of the legged robot are designed on the basis of the moving-direction coordinate system, and therefore, of course, the control system is designed using the moving-direction coordinate system and the control apparatus for the stable control system is manufactured accordingly. The control system based on the moving-direction coordinate system matches human senses, and is therefore reasonable in view of the design method.

However, in the control apparatus designed with the moving-direction coordinate system, it is difficult to build a stable walking control system due to the movement of ground-contacting legs. More specifically, when the legged robot walks on, for example, two legs, the attitude of the robot changes along with the walking state, and control parameters also change accordingly. In addition, since the robot's attitude changes continuously, the rigidity of the robot's body also changes because of the linked structure of the legs. Therefore, there is a risk that oscillation of the control system will occur. Thus, it is difficult to build a walking control system that ensures stability in various kinds of walking patterns.

Accordingly, in order to obtain a stable walking control system, control parameters must be frequently adjusted by trial-and-error. For example, in order to obtain a control system for a stable walking pattern in the moving-direction coordinate system, weighting of input control signals is performed and the rigidity of the control system is reduced to avoid the oscillation. In this case, however, it is difficult to set the characteristics of the control system to desired characteristics.

### DISCLOSURE OF INVENTION

The present invention has been made to solve the above-described problems, and an object of the present invention is to provide a method and an apparatus for walking control of a legged robot using a control system which provides stable attitude control of the legged robot.

In order to attain the above-described object, in a walking control method for a legged robot according to the present invention, walking control is basically performed using a coordinate system based on sole positions and having at least a first coordinate axis in a direction connecting soles of ground-contacting legs or a direction connecting a sole of a ground-contacting leg and a sole of a leg which is about to hit the ground (hereafter simply called a “direction connecting soles of legs”) and a second coordinate axis perpendicular to the first coordinate axis in a horizontal plane (hereafter called a foot-sole coordinate system) as a control coordinate system for the walking control.

In the above-described walking control method, attitude control is performed with different control characteristics for the first and second coordinate axes of the foot-sole coordinate system in the horizontal plane, and the control characteristics are changed depending on the state of the ground-contacting legs detected by ground contact sensors or a motion generator provided in the legged robot.

In addition, according to the present invention, a walking control apparatus for a legged robot having a main body and legs includes a control device and leg actuators controlled by the control device as the basic structure. The control device uses a foot-sole coordinate system based on sole positions and having a first coordinate axis in a direction connecting the soles of the legs, a second coordinate axis perpendicular to the first coordinate axis in a horizontal plane, and a coordinate axis extending in the vertical direction as a control coordinate system for the walking control.

More specifically, the legged robot further includes sole position sensors provided on the legs for detecting the sole positions on which the control coordinate system is based. The sole position sensors may determine the sole positions from kinematic calculations using outputs from angle sensors which detect rotational angles of joints and link-shape data. In addition, the legged robot further includes ground contact sensors which detect the state of the ground-contacting legs and a motion generator for generating the state of the ground-contacting legs, and the control device controls the leg actuators using the foot-sole coordinate system as the control coordinate system for the walking control in accordance with the detected sole positions and the state of the ground-contacting legs.

In addition, in the walking control apparatus for the legged robot according to the present invention, the control device inputs control parameters in the foot-sole coordinate system and sets the control characteristics in accordance with the input control parameters. In this case, the control device changes the control characteristics depending on the state of the ground-contacting legs detected by the ground contact sensors or the motion generator.

In addition, the control device includes coordinate transforming means and performs coordinate transformation of the control characteristics in the foot-sole coordinate system to obtain control parameters in a sensor coordinate system included in the sensors, a moving-direction coordinate system based on the moving direction of the legged robot, or a body coordinate system based on the body of the legged robot. Therefore, the control is performed with the moving-direction coordinate, the body coordinate system, etc. Accordingly, stable control is performed by dynamically changing the control characteristics depending on the state of the legs and performing the coordinate transformation thereof, and thus the stability in the walking control of the legged robot is increased.

More specifically, in the walking control apparatus for the legged robot according to the present invention, the control device changes the control characteristics depending on the state of the ground-contacting legs detected by the ground contact sensors or the motion generator instead of switching the control device itself depending on the walking state (for example, the state of the ground-contacting legs).

Preferably, in the walking control apparatus for the legged robot according to the present invention, the control device further includes coordinate transforming means for transforming sensor information detected in the sensor coordinate system included in the sensors into the foot-sole coordinate system based on the direction connecting the soles of the legs and coordinate transforming means for transforming walking pattern information described in the moving-direction coordinate system into the foot-sole coordinate system based on the direction connecting the soles of the legs. In addition, the control device performs the walking control by transforming control signals generated in the foot-sole coordinate system into signals in other coordinate systems (e.g., the sensor coordinate system, the moving-direction coordinate system, and the body coordinate system).

In general, in the legged robot, the control parameters and the robot's rigidity change depending on the walking attitude. In a biped walking robot, for example, the rigidity in the direction connecting the soles of both legs is high since a closed link structure including both legs is provided, and therefore the robot does not easily fall in this direction. In comparison, in the direction perpendicular to the direction connecting the soles of both legs, the rigidity of the legged robot is low in this walking attitude since the closed link structure including both legs is not provided, and therefore the robot easily falls in this direction.

Accordingly, in the walking control apparatus for the legged robot according to the present invention, the foot-sole coordinate system based on the sole positions is used as a coordinate system suitable for use in the walking control system for the walking attitude control of the legged robot. More specifically, the walking control system is designed and built using a coordinate system having a first coordinate axis in a direction connecting the soles of the legs, a second coordinate axis perpendicular to the first coordinate axis in a horizontal plane, and a coordinate axis extending in the vertical direction, and accordingly a control system which ensures stable walking attitude is obtained.

In addition, since the walking control apparatus according to the present invention performs the walking control using the foot-sole coordinate system, the coordinate transforming means for performing coordinate transformation to the foot-sole coordinate system is provided. Accordingly, the sensor information in the sensor coordinate system and the walking pattern described in the moving-direction coordinate system, for example, are transformed into the foot-sole coordinate system. In addition, the control system is designed and built such that control signals in the foot-sole coordinate system are subjected to reverse coordinate transformation to obtain a walking pattern described in the moving-direction coordinate system. Accordingly, a control system having desired characteristics can be easily designed and built.

### BRIEF DESCRIPTION OF THE DRAWINGS

FIG. 1 is an explanatory diagram showing the schematic structure of a legged robot to which the present invention is applied.

FIG. 2 is a perspective view showing the positions of ground-contacting legs when walking control of the legged robot is performed.

FIG. 3 is an explanatory diagram showing a foot-sole coordinate system according to the present invention.

FIG. 4 is an explanatory diagram showing anisotropic restoring moment in the foot-sole coordinate system.

FIG. 5 is an explanatory diagram showing restoring moment applied in a single support phase in the foot-sole coordinate system.

### BEST MODE FOR CARRYING OUT THE INVENTION

Embodiments of the present invention will be described below with reference to the accompanying drawings.

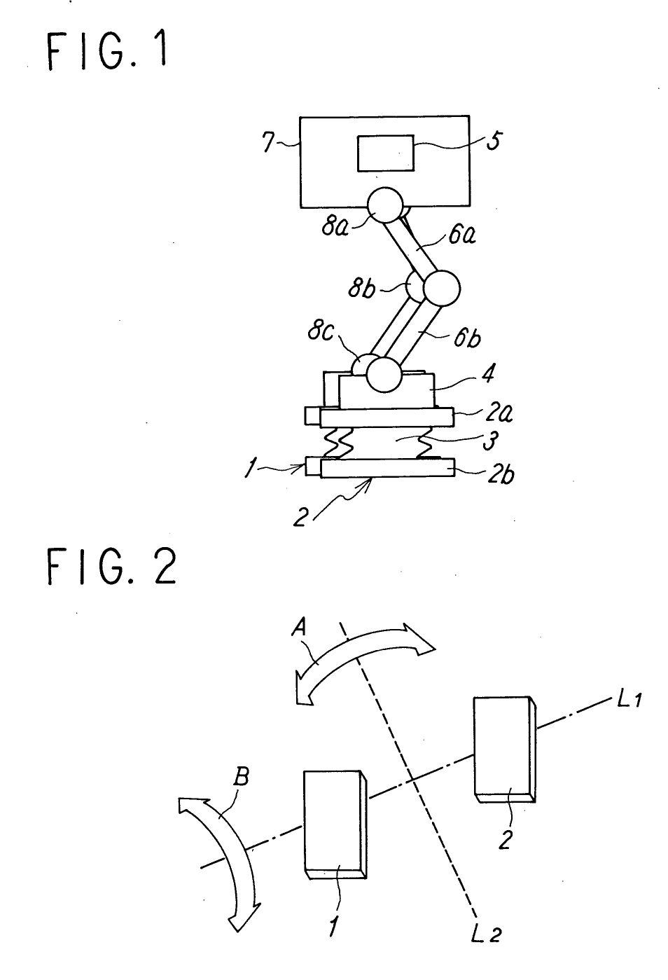

In FIGS. 1 and 2, a main body 7 of a robot is supported by a left lower limb 1 and a right lower limb 2, and an attitude control device 5 is included in the robot's main body 7. In more detail, the right lower limb 2 includes a top plate 2a, a ground contact plate 2b, a low-rigidity member 3 defining a foot, a foot joint mount 4, a first leg member 6a connected to the robot's main body 7, a second leg member 6b placed below the first leg member 6a, a first joint motor 8a placed between the robot's main body 7 and the first leg member 6a, a second joint motor 8b placed between the first leg member 6a and the second leg member 6b, and a third joint motor 8c placed between the second leg member and the foot joint mount 4.

Although only the structure of the right lower limb 2 is described above, the left lower limb 1, of course, has a similar structure. In the following description, a portion including the first and second leg members 6a and 6b and the first to third joint motors 8a to 8c are simply referred to as a leg.

Although not shown in the figure, each of the left and right lower limbs 1 and 2 has a pressure sensor disposed in the low-rigidity member 3, the pressure sensor functioning as a ground contact sensor, and the robot's main body 7 includes an attitude sensor (not shown) for detecting the inclination, etc., thereof. In addition, sole position sensors are provided for calculating sole positions from angle data obtained from angle sensors which detect the rotational angles of joints driven by the joint motors 8a to 8c, link-shape data of the structure including the first and second leg members 6a and 6b, etc.

In addition, the positions of the left and right lower limbs 1 and 2 moved from the initial positions by walking control of the robot are calculated by the attitude control device 5 on the basis of the outputs from the above-described attitude sensor and the sole position sensors. The attitude control device 5 includes a motion control computer (control device) which generates control data by performing coordinate transformation described below and outputs control signals to leg actuators including the joint motors 8a to 8c.

In the walking control of the legged robot, the motion control computer in the attitude control device 5 disposed in the robot's main body 7 moves the legs of the robot, in other words, controls the leg actuators to move the left and right lower limbs 1 and 2 such that the robot walks in accordance with a walking pattern. In operation, the walking control based on the walking pattern is performed by controlling the leg actuators and moving the left and right lower limbs 1 and 2 with control signals output from the motion control computer in the attitude control device 5 which generates the states of the legs.

During the walking control of the legged robot, parameters change depending on the walking attitude of the legged robot. In addition, mechanical rigidities of the robot's main body 7 and the legs also change depending on the walking attitude. More specifically, with reference to FIG. 2, when a biped robot walks, the rigidity in the direction denoted by L1 (hereafter called a longitudinal direction) which connects the soles of both of the ground-contacting legs (the left and right lower limbs 1 and 2) is high since a closed link structure including both legs is provided, and therefore the robot does not easily fall in the direction shown by arrow A. In comparison, in the direction denoted by L2 (hereafter called a transverse direction) which is perpendicular to the longitudinal direction, the rigidity is low since the closed link structure including both legs is not provided, and therefore the robot easily falls in the direction shown by arrow B.

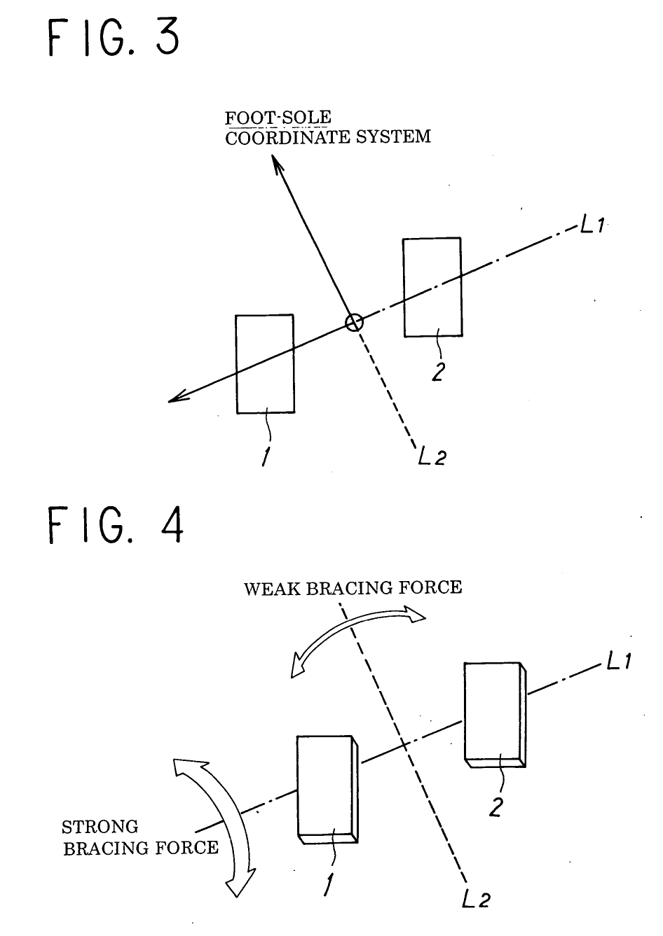

Therefore, according to the present invention, a control system having different control characteristics in the longitudinal and transverse directions is provided for ensuring the stability in the walking control of the legged robot. More specifically, the biped walking robot has different characteristics depending on the directions (longitudinal and transverse directions), and the characteristics change. Accordingly, as shown in FIG. 3, the walking control of the biped walking robot is performed using a foot-sole coordinate system, which is a Cartesian coordinate system including an axis connecting the soles of the legs, as a walking control system. In the foot-sole coordinate system, the coordinate axes change dynamically since the sole positions of the robot change as the legged robot walks. Accordingly, when the walking control is performed, the positions of the ground-contacting legs (the left and right lower limbs 1 and 2) are detected at the time of performing control and the walking control is performed using the foot-sole coordinate system based on the direction connecting the detected sole positions of the legs.

As shown in FIG. 4, in the attitude control performed when both of the legs are in contact with the ground, falling of the robot around the longitudinal axis (L1) is avoided by restoring the attitude with a strong bracing force. In comparison, falling of the robot around the transverse axis (L2) is avoided by restoring the attitude with a weak bracing force since the gap between the feet is large (long) and a moment required for returning the inclined torso (robot's main body 7) to the original position can be generated even when the bracing force is weak.

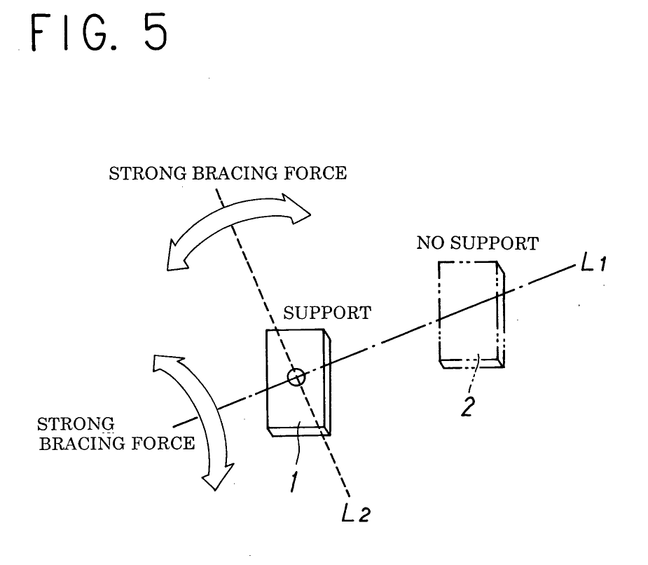

In addition, the walking control of the robot includes a single support phase in which the robot is supported on one leg. Also in this phase, similar to a double support phase in which the robot is supported on both of the legs, the foot-sole coordinate system is set and the walking control is performed using the foot-sole coordinate system without switching the control device. More specifically, in the single support phase, the attitude is restored with a strong bracing force for both the longitudinal and transverse directions, as shown in FIG. 5, since the rigidity is low in both of these directions.

The attitude control based on the foot-sole coordinate system will be described in more detail below. When the torso of the robot (robot's main body 7) is inclined and must be returned to the original position, the bracing force is applied from the soles of the ground contacting legs. Physically, the attitude is restored by applying a compensating moment to the ground from the soles. Since the rigidity differs between the longitudinal and traversal directions depending on the state of the ground-contacting legs as described above, a control system must be designed and build such that it has anisotropy (different control characteristics depending on the direction). The control system may be, for example, a decoupled linear system for generating a compensating moment in each axis of the foot-sole coordinate system, as shown in Equation 1 below:
^{F}M=K_{P}^{F}B^{F}Δθ+Kᵥ^{F}B^{F}Δ\dot{θ} (1)
where

Left Superscript F: represents foot-sole coordinate system

M: restoring moment vector

Δθ: inclination vector of the torso

Kp: proportional gain of the torso's inclination

Kv: velocity gain of the torso's inclination

B: weight matrix for determining the bracing force

When the weight matrix B is a 2×2 matrix, it is expressed as follows:

$${}^{F} B = [ \begin{matrix}b & 0 \\ 0 & 1\end{matrix} ] \qquad ( 2 )$$

where b is a value which satisfies 0 ≦b ≦1 and represents the rate of the bracing force around the transverse axis when the strong bracing force around the longitudinal axis is 1.

Sensors, such as the attitude sensor for detecting the inclination of the robot's main body 7, used for obtaining feedback inputs for the control system normally detect sensor information in a sensor coordinate system fixed to the torso or the like, and not in the foot-sole coordinate system in which the axial directions change depending on the positional relationship between the legs. Accordingly, the inclination vector Δθ, which is a parameter in Equation 1, must be subjected to a coordinate transformation from the sensor coordinate system to the foot-sole coordinate system, as shown in Equations 3-1 and 3-2 below:
^{F}Δθ=_{S}^{F}R^{S}Δθ (3-1)
^{F}Δ\dot{θ}=_{S}^{F}R^{S}Δ\dot{θ} (3-2)

In the above equations, the left superscript S represents the sensor coordinate system and R represents a coordinate transformation matrix which transforms data in a coordinate system indicated by the left subscript into data in a coordinate system indicated by the left superscript.

In addition, walking patterns are normally described in a moving-direction coordinate system which is different from the foot-sole coordinate system. When, for example, the robot walks while it's body always faces forward, the walking patterns are described in a body coordinate system which is based on the body. Accordingly, in order to build a desired stable control system, a compensation signal in the foot-sole coordinate system obtained from Equation 1 must be transformed into a signal in the body coordinate system, as shown in Equation 4, before applying the compensation to the walking pattern.
^{B}M=_{F}^{B}R^{F}M (4)
where the superscript B represents the body coordinate.

Accordingly, stable control of the legged robot is effectively achieved by generating a compensating moment in the body coordinate system using a control system shown in Equation 5 below in the attitude control device 5.
^{B}M=_{F}^{B}R Kₚ^{F}B_{S}^{F}R^{S}Δθ+R Kᵥ^{F}B_{S}^{F}R^{S}Δ\dot{θ} (5)

As is clear from Equation 5, the gains are variable depending on the walking attitude in the body coordinate system, and the desired stable control system expressed by Equation 1 can be built for various kinds of walking patterns.

In addition, when the coordinate transformation from the foot-sole coordinate system to the body coordinate system shown in Equations 4 and 5 is substituted by a coordinate transformation from the sole coordinate system to the moving-direction coordinate system, the gains are also variable in the moving-direction coordinate system and the desired stable control system expressed by Equation 1 can be built for various kinds of walking patterns.

In the walking control of the legged robot, mode switching is often performed depending on the state of the ground-contacting legs. However, in such a case, the control system is complex and the stability thereof is reduced. Therefore, here the control system is built such that the weight used in Equation 2 is changed continuously. In a biped walking robot, for example, when the robot is in the single support phase, the sole of the leg must apply a strong bracing force in all directions, as shown in FIG. 5. In addition, there is a risk that the robot will fall if the restoring moment calculated by Equation 1 is changed discontinuously, and therefore it is necessary to change the restoring moment continuously. Accordingly, it is determined whether the robot is in the single support phase or the double support phase on the basis of the output from the ground contact sensors which detect the state of the ground-contacting legs and the walking pattern obtained from a motion generator which generates the state of the legs, and the weight b used in Equation 2 is changed continuously depending on the result of the determination. The weight b is set to 1 in the single support phase.

As described above, the walking control apparatus according to the present invention performs the walking control using the foot-sole coordinate system. Accordingly, the walking control apparatus includes coordinate transforming means for performing coordinate transformation to the foot-sole coordinate system. For example, the sensor information in the sensor coordinate system, the walking pattern described in the moving-direction coordinate system or the body coordinate system, etc., are transformed into the foot-sole coordinate system. In addition, inverse transformation of the foot-sole coordinate system is performed to apply compensation to the walking pattern described in the moving-direction coordinate system or the body coordinate system. Accordingly, a control system having desired characteristics can be easily designed and built.

1. A walking control method for a legged robot, wherein walking control is performed using a foot-sole coordinate system based on sole positions and having at least a first coordinate axis in a direction connecting soles of legs and a second coordinate axis perpendicular to the first coordinate axis in a horizontal plane as a control coordinate system for the walking control.

2. The walking control method for the legged robot according to claim 1, wherein attitude control is performed with different control characteristics for the first and second coordinate axes of the foot-sole coordinate system in the horizontal plane.

3. The walking control method for the legged robot according to claim 2, wherein the control characteristics are changed depending on the state of ground-contacting legs detected by ground contact sensors or a motion generator provided in the legged robot.

4. A walking control apparatus for a legged robot having a main body and legs, the walking control apparatus comprising a control device using a foot-sole coordinate system based on sole positions and having a first coordinate axis in a direction connecting the soles of the legs, a second coordinate axis perpendicular to the first coordinate axis in a horizontal plane, and a coordinate axis extending in the vertical direction as a control coordinate system for the walking control.

5. The walking control apparatus for the legged robot according to claim 4, further comprising sole position sensors on the legs, the sole position sensors detecting the sole positions, wherein the control device controls leg actuators provided on the legs for walking on the basis of the sole positions detected by the sole position sensors.

6. The walking control apparatus for the legged robot according to claim 5, further comprising ground contact sensors on the legs, the ground contact sensors detecting the contact states of the legs, wherein the control device performs the walking control by performing a coordinate transformation to a coordinate system based on the direction connecting the soles of the legs in accordance with the sole positions detected by the sole position sensors and the contact states detected by the ground contact sensors.

7. The walking control apparatus for the legged robot according to claim 5, further comprising a motion generator for generating the state of ground-contacting legs, wherein the control device performs the walking control by performing a coordinate transformation to a coordinate system based on the direction connecting the soles of the legs in accordance with the sole positions detected by the sole position sensors and a motion state detected by the motion generator.

8. The walking control apparatus for the legged robot according to claim 5, wherein the control device inputs control parameters with a coordinate system based on the sole positions detected by the sole position sensors and sets control characteristics in accordance with the input control parameters.

9. The walking control apparatus for the legged robot according to claim 6, wherein the control device changes the control characteristics depending on the state of the ground-contacting legs detected by the ground contact sensors or the motion generator.

10. The walking control apparatus for the legged robot according to claim 6, wherein the control device includes coordinate transforming means for transforming sensor information detected in a coordinate system included in the sensors into the foot-sole coordinate system based on the sole positions of the ground-contacting legs.

11. The walking control apparatus for the legged robot according to claim 6, wherein the control device includes coordinate transforming means for transforming motion pattern information described in a coordinate system based on the moving direction into the foot-sole coordinate system based on the direction connecting the soles of the legs.

12. The walking control apparatus for the legged robot according to claim 10, further comprising coordinate transforming means for transforming signals generated in the foot-sole coordinate system based on the direction connecting the soles of the legs into one of the sensor coordinate system included in the sensors, the moving-direction coordinate system based on the moving direction of the legged robot, and a body coordinate system based on the body of the legged robot.

13. The walking control apparatus for the legged robot according to claim 7, wherein the control device changes the control characteristics depending on the state of the ground-contacting legs detected by the ground contact sensors or the motion generator.

14. The walking control apparatus for the legged robot according to claim 7, wherein the control device includes coordinate transforming means for transforming sensor information detected in a coordinate system included in the sensors into the foot-sole coordinate system based on the sole positions of the ground-contacting legs.

15. The walking control apparatus for the legged robot according to claim 7, wherein the control device includes coordinate transforming means for transforming motion pattern information described in a coordinate system based on the moving direction into the foot-sole coordinate system based on the direction connecting the soles of the legs.

16. The walking control apparatus for the legged robot according to claim 11, further comprising coordinate transforming means for transforming signals generated in the foot-sole coordinate system based on the direction connecting the soles of the legs into one of the sensor coordinate system included in the sensors, the moving-direction coordinate system based on the moving direction of the legged robot, and a body coordinate system based on the body of the legged robot.

17. The walking control apparatus for the legged robot according to claim 14, further comprising coordinate transforming means for transforming signals generated in the foot-sole coordinate system based on the direction connecting the soles of the legs into one of the sensor coordinate system included in the sensors, the moving-direction coordinate system based on the moving direction of the legged robot, and a body coordinate system based on the body of the legged robot.

18. The walking control apparatus for the legged robot according to claim 15, further comprising coordinate transforming means for transforming signals generated in the foot-sole coordinate system based on the direction connecting the soles of the legs into one of the sensor coordinate system included in the sensors, the moving-direction coordinate system based on the moving direction of the legged robot, and a body coordinate system based on the body of the legged robot.
